(19) United States
(12) Patent Application Publication
(10) Pub. No.: US 2008/0168858 A1
(43) Pub. Date: Jul. 17, 2008

(54) FLYWHEEL STABILITY SLEEVE

(76) Inventors: Daniel Bakholdin, Canyon Country, CA (US); Daryl Kobayashi, Pasadena, CA (US)

Correspondence Address: CHANCELLOR IP, 3463 RED BLUFF CT., SEMI VALLEY, CA, 93063, US

(21) Appl. No.: 12/013,180

(22) Filed: Jan. 11, 2008

Related U.S. Application Data
(60) Provisional application No. 60/884,472, filed on Jan. 11, 2007.

(51) Int. Cl. H02K 7/02

(52) U.S. Cl. 74/572.11

(57) ABSTRACT

A flywheel rotating assembly has a flywheel mass that receives a sleeve that receives peripheral portions of a hub that is mounted on a shaft.

This application claims the benefit of and incorporates by reference U.S. Provisional Patent Application 60/884,472 filed Jan. 11, 2007. This application incorporates by reference U.S. Pat. Nos. 7,078,876 to Hoffmann et al. issued Jul. 18, 2006, 7,109,622 to Khalizadeh issued Sep. 19, 2006, 5,708,312 to Rosen et al. issued Jan. 13, 1998 and 5,998,899 to Rosen et al. issued Dec. 7, 1999.

### BACKGROUND OF THE INVENTION

1. Field of Invention

The present invention relates to the mechanical arts and energy storage systems. In particular, the present invention relates to flywheel systems having high-speed rotating assemblies.

2. Description of the Related Art

The engineering community has long believed that high speed composite flywheels are not practical due to an inability to design a rotating assembly that has stable balance characteristics.

### SUMMARY OF THE INVENTION

Now, in accordance with the invention, there has been found a flywheel rotating assembly that provides stable balance characteristics even when the rotating assembly rotates at high speeds including a speed of 60,000 revolutions per minute. A flywheel assembly comprises a rotatable shaft supplying mechanical energy to and receiving mechanical energy from a means for exchanging mechanical energy; a hub has a central passage and first and second peripheral projections and the central passage receives at least a portion of the shaft; a mass for storing kinetic energy has a central cavity; the first peripheral projection is immovably coupled to a sleeve and the second peripheral projection is slidably engaged with the sleeve; and, the mass receives in its central cavity at least a portion of the sleeve.

In an embodiment, the means for exchanging mechanical energy is an electric motor and an electric generator. In another embodiment the means for exchanging mechanical energy is an electric motor-generator. And in some embodiments, the shaft is a multi-part shaft.

### BRIEF DESCRIPTION OF THE DRAWINGS

The present invention is described with reference to the accompanying drawings that illustrate the present invention and, together with the description, explain the principles of the invention enabling a person skilled in the relevant art to make and use the invention.

FIG. 1A is a perspective drawing showing a rotating assembly of a flywheel.

FIG. 1B is a cross-section of the rotating assembly of FIG. 1A taken along lines Z-Z.

FIG. 1C is an exploded view of area “A” of the cross-section of FIG. 1B of the rotating assembly of FIG. 1A.

FIG. 2 is an exploded view of a portion of the rotating assembly of FIG. 1A.

### DESCRIPTION OF THE PREFERRED EMBODIMENTS

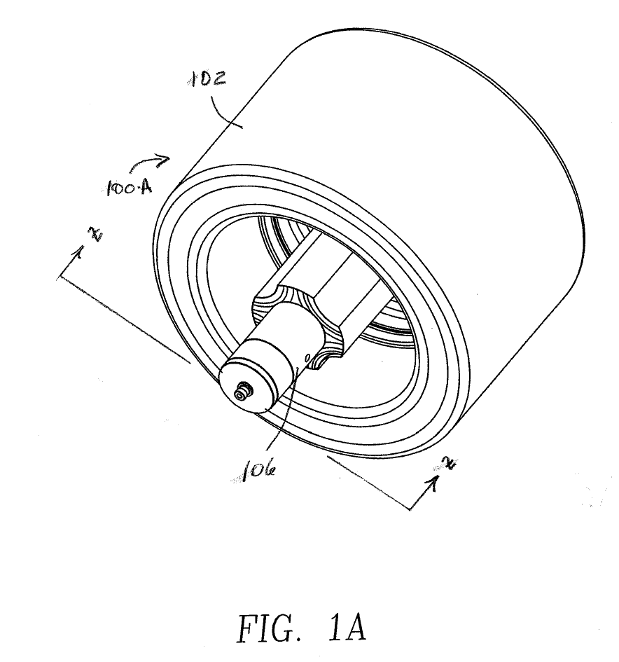

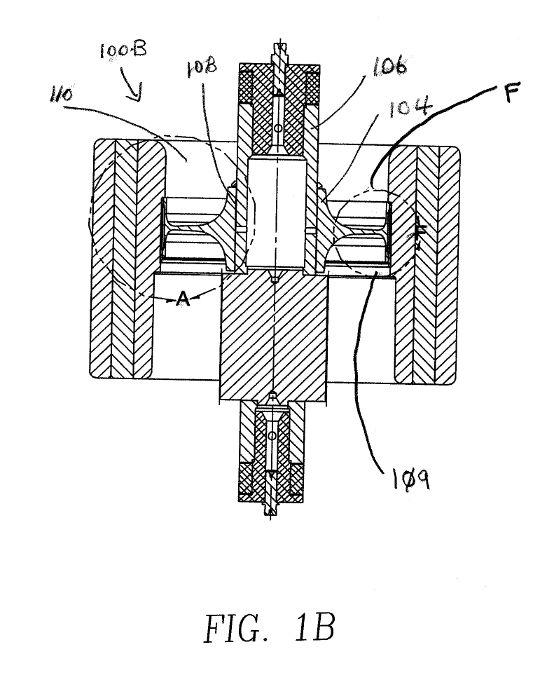

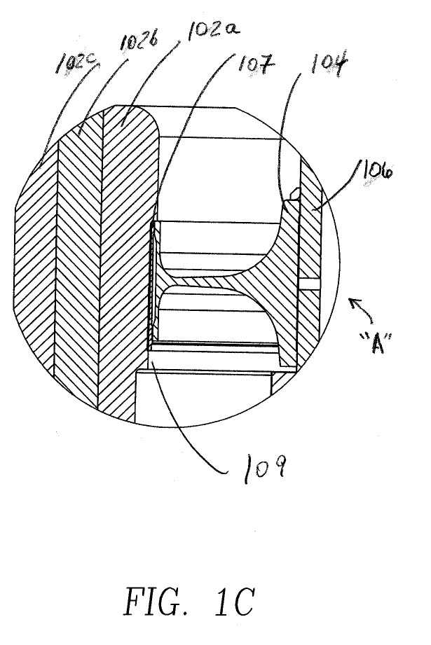

FIG. 1A shows a rotating group assembly 100A of an embodiment of the flywheel of the present invention. The rotating group assembly includes a flywheel mass or rim 102, a shaft 106, a hub 104 and a sleeve 107. A central opening in the hub 108 receives at least a portion of the shaft and a cavity in the rim 110 receives at least a portion of the hub.

FIG. 1B shows a cross-sectional view 100B, taken along lines z-z, of the rotating group assembly of FIG. 1A. The hub 104 spans between the shaft 106 and an inner portion of the rim 102a. As shown in FIG. 1C, an exploded view of the area marked “A” of FIG. 1B, separating the hub from an inner portion of the rim is the sleeve 107. The sleeve 107 is therefore received by the cavity 109 in the rim 102.

In an embodiment, the rim 102 is made from composites such as graphite fibers in a suitable matrix. In some embodiments, multiple layers of composites are used. And in one embodiment, three layers of composites are used comprising an inner layer 102a, a middle layer 102b and an outer layer 102c, the inner layer having a high mass and low modulus of elasticity as compared to the other layers.

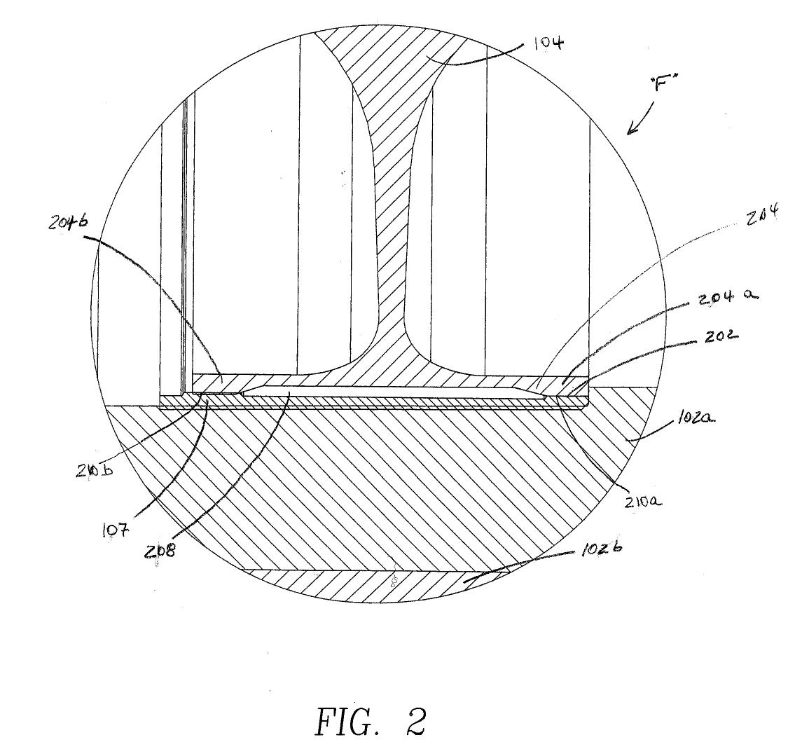

FIG. 2 shows an exploded view of the area marked “F” of FIG. 1B. The hub 104 has a radial periphery in the form of a circular flange 204. In an embodiment, the flange has radial projections or feet at its opposed edges 204a,b and these projections are received by the sleeve 107.

In some embodiments, one or more of the hub-shaft, hub-sleeve, and sleeve-rim interfaces are interference fits. And in some embodiments, one or more of these interfaces are fixed with an adhesive such as epoxy or another suitable adhesive. In an embodiment, one of the feet 204a,b is welded to the sleeve 107 and the other is slidably engaged with the sleeve. And, in an embodiment the slidably engaged foot and/or the mating areas of the sleeve are coated with an anti-friction material such as a vacuum compatible dry-film lubricant. In an embodiment the anti-friction material is Tiodize® brand anti-friction material.

Due to the large variations in diameter that the spinning rim 102 experiences, between the non-rotating case and full operational speed case, a compliant hub 104 is used to couple the rim to the shaft 106 which may be a multi-part shaft. A rim, in this case, refers to the energy storing mass of the flywheel in the shape of a cylindrical wheel, but can apply to any figure of revolution. In order to perform its above described function, such a hub is designed to accommodate these large changes in diameter without exceeding allowable levels of mechanical stress. Doing this requires that this hub act as a compliant coupling between the central shaft and the rim. This results in natural resonant modes where the two dominant masses, namely the rim and central shaft, move relative to one another, with the hub functioning as a spring between the two masses. It is desirable to design this mass-spring system in such a manner that these natural resonant frequencies are higher than the operating speed of the flywheel. Achieving this characteristic requires a hub compliant enough to minimize material stresses while also acting as a spring stiff enough to result in sufficiently high resonant frequencies. In the case of an embodiment of the present invention, this was achieved by utilizing two contact points 210a,b resulting from peripheral projections 204a,b of the hub where the hub is coupled with the rim. In this embodiment, a gap 208 is formed between the two feet.

As a result of Poisson's ratio and geometry, these two contact points 210a,b experience variation in axial position, relative to one another, as the flywheel changes rotational speed. (These contact points result from the hub's peripheral projections which may be referred to as “feet”). At zero spin speed, because the hub is being compressed radially inward by the rim 102, the feet are slightly closer together than in the relaxed state. As the wheel is accelerated and the rim expands, the feet follow the inner diameter of the rim. At an intermediate speed, the feet are at a position where the distance between them is at its maximum. As the wheel accelerates beyond this maximum spacing, the spacing again decreases until it reaches a minimum distance at full speed. Several factors that effect this foot movement can contribute to changes in the mass balance of the rotating assembly 100a.

If the hub feet 204a,b are not bonded, or by some method “fixed” to the rim 102, an “inch worming” effect can take place, resulting in a change of the hubs 104 axial position on the rim. If this change in axial position is not identical throughout the circumference of the foot to rim interface, a change in mass balance occurs. In such a case, this mass balance instability is common due to variations in friction coefficient between the hub feet and the rim. One solution would seem to be to “fix” the feet to the rim. But, restricting the movement of the feet relative to each other results in unacceptable stress levels and the loss of the hub's ability to grow with the rim. Also, bonding metallic hub feet to the fiber/epoxy composite rim is difficult, if not impossible, and at best unreliable considering the shear loads generated on the relatively small contact areas 210a,b. An unexpected solution to solving this problem is to bond only one of the two feet to the rim. This allows the other foot to slide freely against the rim. The result is a “determinate” case, which assures that the hub remains in the same axial location relative to the rim after cycling the speed of the rotating assembly 100a.

As mentioned earlier, bonding the relatively small contact area 210a,b of the single hub foot 204a,b to the fiber/epoxy composite of the rim 102 does not provide a reliable bond. Also the “free” hub foot sliding on the composite material would experience unacceptable friction and wear to the rim, resulting in both balance instability and loss of contact interference required in some embodiments.

In the present invention, a metallic stability sleeve 107 was introduced between the hub feet 204a,b and the rim 102 to resolve this problem. Using a sleeve constructed of the same metal as the hub 104, in this case titanium, allows the hub and sleeve to be welded together at one of the feet while allowing the other hub foot to slide freely on the inner diameter of the sleeve. Special surface treatment to the titanium contact surfaces, in this case Tiodize, results in a low friction contact. This is important to ensure that the hub foot consistently returns to the same location after each spin cycle. Where the hub to rim interface did not result in a continuous contact patch between the feet and therefore only a small area was available for bonding, the sleeve results in a large contact patch with the rim and lends itself to a strong bond with the rim using a compatible adhesive.

The use of a stability sleeve 107, as described above, results in a dynamically stable rotating assembly 100-A with exceptional balance stability. The hub 104 and sleeve material are not limited to titanium and are also not limited to being constructed of similar metals. Welding and brazing methods are available that can weld dissimilar metals. Also one can devise other attachment methods to serve the purpose of “fixing” the hub to sleeve interface. One example would be pinning to prevent sliding at that interface. Ensuring a consistent and low friction interface at the free end is also not limited to Tiodize. One can utilize any number of surface treatments or lubrication methods to satisfy this need.

While various embodiments of the present invention have been described above, it should be understood that they have been presented by way of example only, ant not limitation.

What is claimed is:

1. A flywheel assembly comprising;
a rotatable shaft supplying mechanical energy to and receiving mechanical energy from a means for exchanging mechanical energy;
a hub having a central passage and first and second peripheral projections, said central passage receiving at least a portion of the shaft;
a mass for storing kinetic energy, said mass having a central cavity;
the first peripheral projection immovably coupled to a sleeve;
the second peripheral projection slidably engaged with the sleeve; and,
the mass receiving in its central cavity at least a portion of the sleeve.

2. The flywheel assembly of claim 1 wherein the means for exchanging mechanical energy is an electric motor and an electric generator.

3. The flywheel assembly of claim 1 wherein the means for exchanging mechanical energy is an electric motor-generator.

4. The flywheel assembly of claim 3 wherein an anti-friction material separates at least a portion of the second peripheral projection and the sleeve.

5. The flywheel assembly of claim 4 wherein the anti-friction material is a vacuum compatible dry-film lubricant.
